(19) United States
(12) Patent Application Publication
(10) Pub. No.: US 2010/0097424 A1
(43) Pub. Date: Apr. 22, 2010

(54) INK-JET HEAD

(75) Inventors: Pil-Joong KANG, Jinju-si (KR); Jae-Woo Joung, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/480,234

(22) Filed: Jun. 8, 2009

(30) Foreign Application Priority Data
Oct. 20, 2008 (KR) 10-2008-0102413

(51) Int. Cl. B41J 2/14

(52) U.S. Cl. 347/47

(57) ABSTRACT

An ink-jet head is disclosed. The ink-jet head in accordance with an embodiment of the present invention, including a reservoir, which stores ink, a chamber, which is supplied with the ink from the reservoir, a restrictor, which connects the reservoir with the chamber, a nozzle, which ejects the ink, and a damper, which is interposed between the chamber and the nozzle, can include: a body, in which the chamber, the reservoir, the restrictor and the damper are formed; and a nozzle plate, which is coupled to the body and in which the nozzle is formed on the nozzle plate, in which the nozzle plate is made of a transparent material, and an observation window is formed on the nozzle plate and apart from the nozzle for observation of a meniscus formed in the nozzle.

### CROSS-REFERENCE TO RELATED APPLICATIONS

This application claims the benefit of Korean Patent Application No. 10-2008-0102413, filed with the Korean Intellectual Property Office on Oct. 20, 2008, the disclosure of which is incorporated herein by reference in its entirety.

### BACKGROUND

1. Technical Field

The present invention relates to an ink-jet head.

2. Description of the Related Art

An ink-jet head is an apparatus for ejecting a droplet of ink through a nozzle by transforming an electric signal to a physical force. The ink-jet head is manufactured by forming different components, such as a chamber, a restrictor, a nozzle and a damper, on several layers and stacking these layers with one another. Not only is the ink-jet technology used for industrial applications, for example, when printing on conventional paper or cloth in the graphic inkjet industry, but it is also used for manufacturing electronic components, such as a printed circuit board (PCB) or an LCD panel.

For this reason, the ink-jet printing technology has recently been often used in the electronic component manufacturing sector. However, there has been a demand for a controlling technology with respect to ejecting properties, such as the size of the droplets being ejected and the deviation of ejecting speed.

Since such ejecting properties are dependent on the movement of meniscuses formed in a corresponding nozzle when the ink-jet head is in operation, it is imperative that the meniscuses formed in the nozzle be observed to assess the ejecting properties of the ink-jet head.

### SUMMARY

The present invention provides an ink-jet head in which a meniscus formed in a nozzle can be easily observed for the assessment of ejecting properties of ink.

An aspect of the present invention provides an ink-jet head. The ink-jet head in accordance with an embodiment of the present invention, including a reservoir, which stores ink, a chamber, which is supplied with the ink from the reservoir, a restrictor, which connects the reservoir with the chamber, a nozzle, which ejects the ink, and a damper, which is interposed between the chamber and the nozzle, can include: a body, in which the chamber, the reservoir, the restrictor and the damper are formed; and a nozzle plate, which is coupled to the body and in which the nozzle is formed on the nozzle plate, in which the nozzle plate is made of a transparent material, and an observation window is formed on the nozzle plate and apart from the nozzle for observation of a meniscus formed in the nozzle.

Here, the body can be made of a silicon material; and the nozzle plate can be made of a glass material.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view illustrating an ink-jet head in accordance with an embodiment of the present invention.

FIG. 2 is a bottom view having enlarged an observation window and a nozzle illustrated in FIG. 1.

FIG. 3 is a cross-sectional view having enlarged the observation window and the nozzle shown in FIG. 1.

FIGS. 4 to 12 illustrate a method of manufacturing an ink-jet head in accordance with an embodiment of the present invention.

### DETAILED DESCRIPTION

As the invention allows for various changes and numerous embodiments, a particular embodiment will be illustrated in the drawings and described in detail in the written description. However, this is not intended to limit the present invention to a particular mode of practice, and it is to be appreciated that all changes, equivalents, and substitutes that do not depart from the spirit and technical scope of the present invention are encompassed in the present invention.

An ink-jet head according to a certain embodiment of the present invention will be described below in more detail with reference to the accompanying drawings. Those components that are the same or are in correspondence are rendered the same reference numeral regardless of the figure number, and redundant descriptions are omitted.

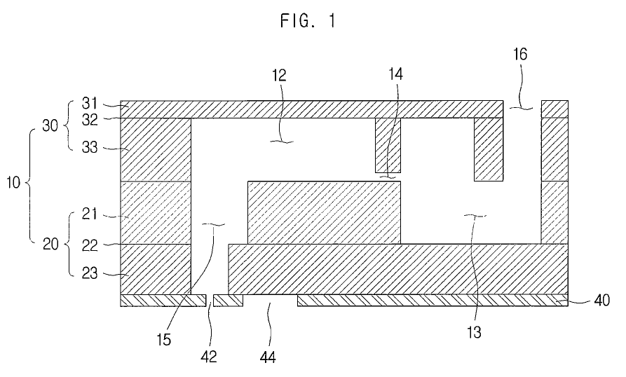

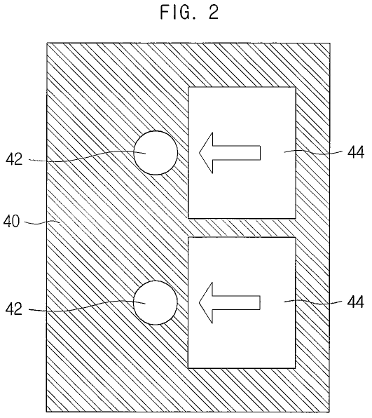

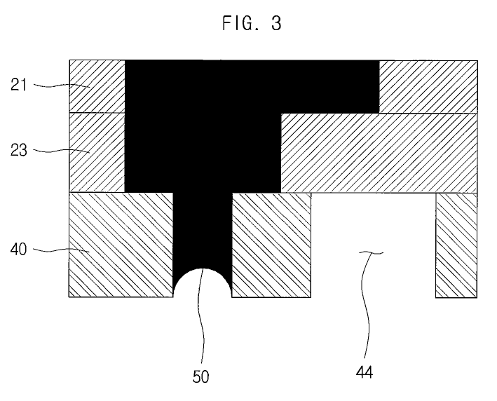

FIG. 1 is a cross-sectional view illustrating an ink-jet head in accordance with an embodiment of the present invention; FIG. 2 is a bottom view having enlarged an observation window and a nozzle illustrated in FIG. 1; and FIG. 3 is a cross-sectional view having enlarged the observation window and the nozzle illustrated in FIG. 1. Illustrated in FIGS. 1 to 3 are a body 10, a chamber 12, a reservoir 13, a restrictor 14, a damper 15, an inlet 16, SOI substrates 20 and 30, upper silicon layers 21 and 31, insulation layers 22 and 32, lower silicon layers 23 and 33, a nozzle plate 40, a nozzle 42 and an observation window 44.

The chamber 12, which contains ink, is a device for ejecting the ink by moving the contained ink to the nozzle 42, when pressure is applied by an actuator (not shown) formed on an upper surface of a vibrating plate 31.

The reservoir 13 is supplied with ink from the outside through the inlet 16, stores the ink and provides the ink to the chamber 12 described above.

The restrictor 14 links the reservoir 13 with the chamber 12 and can function as a channel controlling a flow of ink between the reservoir 13 and the chamber 12. The restrictor 14 is formed to have a smaller sectional area than those of the reservoir 13 and the chamber 12 such that the restrictor 14 can control the amount of ink supplied to the chamber 12 from the reservoir 13 when the vibrating plate 31 is vibrated by the actuator (not shown).

The nozzle 42 is connected to the chamber 12 such that the ink can be supplied from the chamber 12 and ejected. When the vibration generated by the actuator is supplied to the chamber 12 through the vibrating plate, pressure can be applied on the chamber 12, and thus the nozzle 42 can eject the ink by the pressure.

The damper 15 is interposed between the chamber 12 and the nozzle 42. The damper 15 can concentrate the energy generated from the chamber 12 to the nozzle 42 and dampen a rapid change in pressure.

The ink-jet head in accordance with the present embodiment is largely constituted by the body 10 and the nozzle plate 40. The chamber 12, the reservoir 13, the restrictor 14 and the damper 15, which have been described above, are formed on the body 10, and the nozzle 42 and the observation window 44, which have been described above, are formed on the nozzle plate 40.

The observation window 44 is used for observing a meniscus 50 being formed inside the nozzle 42 and on the nozzle 42. The observation window 44 can be formed a slight distance apart from the nozzle 42. It is preferable that the observation window 44 is formed close to the nozzle 42 such that the meniscus 50 formed inside the nozzle 42 and on the nozzle can be closely observed. Here, the nozzle plate 40, in which the nozzle 42 and the observation window 44 are formed, can be made of a transparent material, for example, a glass wafer. The magnified views of the observation window 44 and the nozzle 42 are illustrated in FIGS. 2 and 3.

The body 10, in which the chamber 12 and the reservoir 13 are formed, can be made of a silicon material. By forming the body 10 through the use of a silicon wafer and forming the nozzle plate 40 through the use of a glass wafer, an anodic bonding between the silicon and the glass can be implemented at a contact surface between the body 10 and the nozzle plate 40, and thus improved product reliability based on the strong adhesive strength can be expected.

The body 10 can be formed by stacking a plurality of silicon wafers, formed by stacking a silicon wafer with a SOI substrate, or made of a single silicon wafer. In the present embodiment, however, the body 10 is presented by stacking a pair of SOI substrates 20 and 30.

When forming the body 10 by processing the SOI substrates 20 and 30, in which the insulation layers 22 and 32, for example, SiO₂, are interposed between the silicon layers 21, 31, 23 and 33, the insulation layers 22 and 32 interposed between the silicon layers 21, 31, 23 and 33 function as an etch stop, and thus the depth of the chamber 12 and reservoir 13 and the thickness of the vibrating plate 31 can be obtained more securely.

Hitherto, the structure of an ink-jet head in accordance with an embodiment of the present invention has been described. Hereinafter, a method of manufacturing an ink-jet head in accordance with an embodiment of the present invention will be described.

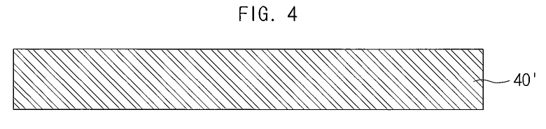

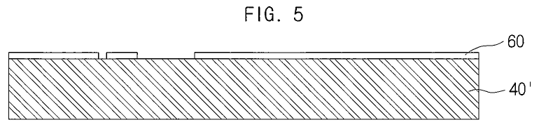

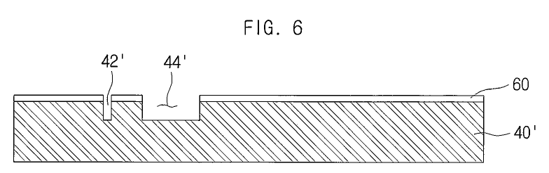

Firstly, as illustrated in FIG. 4, a glass wafer 40′ with a sufficient thickness is prepared, and then an etching resist 60, which is patterned, is formed on an upper surface of the glass wafer 40′. That is, as illustrated in FIG. 5, the etching resist 60, in which the portion where the nozzle 42 and the observation window 44 are to be formed is selectively opened, is formed on the upper surface of the glass wafer.

Then, grooves 42′ and 44′ corresponding to the nozzle 42 and the observation window 44 are formed on the upper surface of the glass wafer 40′. As a method of processing the upper surface of the glass wafer 40′, a reactive ion etching (RIE) process, which is advantageous for controlling a vertical shape, can be used. However, it shall be obvious that other processing methods than the one described above can be also used.

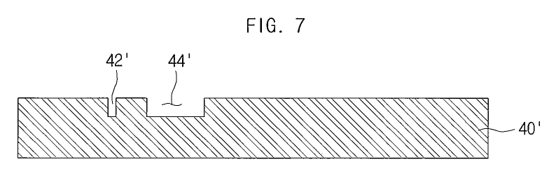

FIG. 7 illustrates the glass wafer 40′, on which the grooves 42′ and 44′ corresponding to the nozzle 42 and the observation window 44 are formed and from which the etching resist 60 is removed.

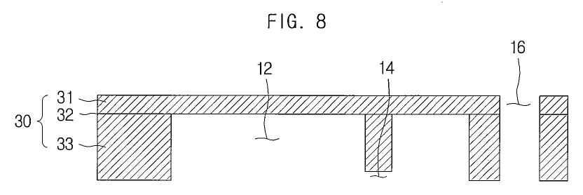

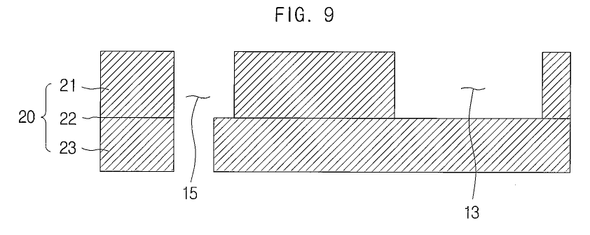

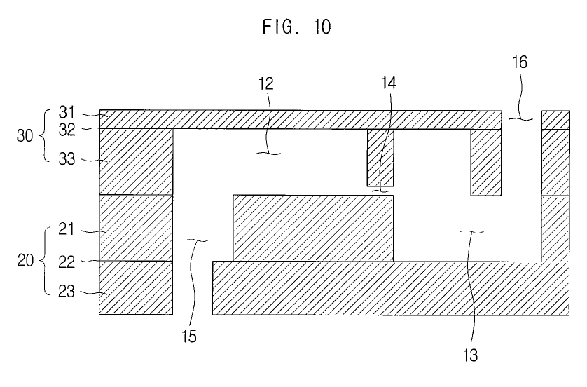

In a separate process, the body 10 is formed. To do this, the chamber 12 and the inlet 16 are formed in the upper silicon layer 31 and the lower silicon layer 33 of the first SOI substrate 30, as illustrated in FIG. 8. Then, the damper 15 and the reservoir 13 are formed in the upper silicon layer 21 and the lower silicon layer 23 of the second SOI substrate 20, as illustrated in FIG. 9. And then, the first and second SOI substrates 20 and 30 are coupled to each other, as illustrated in FIG. 10.

While this embodiment presents a method of forming the body 10 by using the two SOI substrates 20 and 30, it shall be apparent that there can be other various methods to form the body 10.

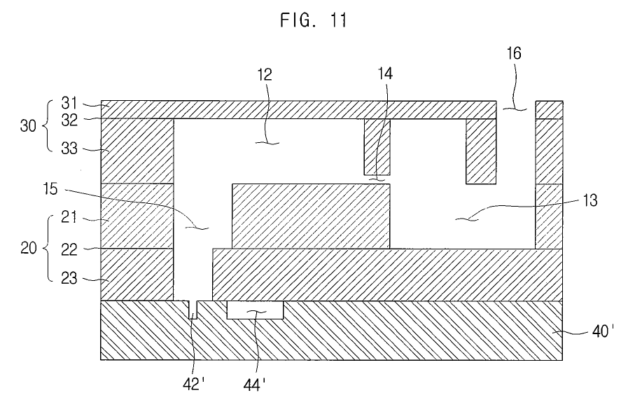

Next, the glass wafer 40′ is coupled to a lower surface of the body 10, and then a lower surface of the glass wafer 40′ is polished, as illustrated in FIG. 11. To polish the glass wafer 40′, a chemical mechanical polishing process can be used, thereby optimizing the process and securing the quality.

In case the body 10 is made of a silicon material, the anodic bonding between the silicon and the glass can be implemented at the contact surface between the body 10 and the nozzle plate 40, and thus improved product reliability based on the strong adhesive strength can be expected.

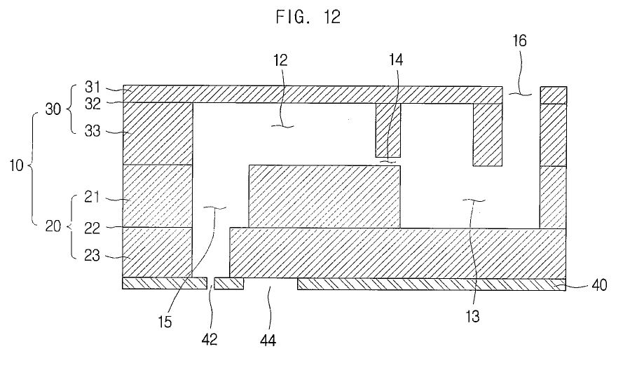

Illustrated in FIG. 12 is an ink-jet head manufactured through the processes described above.

While the spirit of the invention has been described in detail with reference to a particular embodiment, the embodiment is for illustrative purposes only and shall not limit the invention. It is to be appreciated that those skilled in the art can change or modify the embodiment without departing from the scope and spirit of the invention. As such, many embodiments other than that set forth above can be found in the appended claims.

What is claimed is:

1. An ink-jet head comprising a reservoir configured to store ink, a chamber configured to be supplied with the ink from the reservoir, a restrictor configured to connect the reservoir with the chamber, a nozzle configured to eject the ink, and a damper interposed between the chamber and the nozzle, the ink-jet head comprising:
a body in which the chamber, the reservoir, the restrictor and the damper are formed; and
a nozzle plate being coupled to the body and having the nozzle formed therein,
wherein the nozzle plate is made of a transparent material, and an observation window is formed on the nozzle plate and apart from the nozzle for observation of a meniscus formed in the nozzle.

2. The ink-jet head of claim 1, wherein:
the body is made of a silicon material; and
the nozzle plate is made of a glass material.
